(19) United States
(12) Patent Application Publication
(10) Pub. No.: US 2013/0151271 A1
(43) Pub. Date: Jun. 13, 2013

(54) SYSTEM AND A METHOD FOR CARE COORDINATION IN HEALTHCARE

(71) Applicants: Rajesh Kanaka Toleti, Orlando, FL (US); Chakravanty Kalyan Toleti, Windermere, FL (US); Nageshwara Rao Vempaty, Saratoga, CA (US)

(72) Inventors: Rajesh Kanaka Toleti, Orlando, FL (US); Chakravanty Kalyan Toleti, Windermere, FL (US); Nageshwara Rao Vempaty, Saratoga, CA (US)

(73) Assignee: Greater Software Inc., Orlando, FL (US)

(21) Appl. No.: 13/323,716

(22) Filed: Dec. 12, 2011

(51) Int. Cl. G06Q 50/22

(52) U.S. Cl. 705/2

(57) ABSTRACT

A system and a method are provided for care coordination in healthcare. The system consists of a network of one or more kiosks or one or more mobile devices and one or more backend healthcare information systems. The method works by retrieving the patient information from backend systems, by identifying and prioritizing any gaps in care, and messaging to the patient and/or the provider with specific care coordination steps. The system verifies whether a gap in care has been addressed by asking the patient during an automatic call made to the patient to make an appointment to address a gap in care, a check in, a check out and/or listening to the claims data for the patient at the payer. Our invention is useful for care coordination for addressing patients' gaps in care, especially when multiple parties and/or diseases exist.

### SUMMARY OF THE INVENTION

Our invention consists of a system and a method for coordinating care in healthcare. We address the problem of gaps in care. Our system consists of one or more kiosks or one or more mobile devices that are networked to one or more backend information systems There may be a plurality of parties involved in providing care to a patient, including the primary provider, specialist provider(s), providers' staff, payer(s), pharmacy benefit manager(s) (PBMs), pharmacy(s), laboratories, imaging services and others. The method disclosed in our invention gathers information about patient health and also rules and guidelines from various backend sources. It proactively searches this information for the patient roster at a provider to identify gaps in care. It then notifies the appropriate parties, such as the patient, to make an appointment to address the identified gap(s) in care. When a patient visits the provider, he/she interacts with the system for check-in, via a kiosk or a mobile device. A further review of systems may be conducted to identify further gaps in care and the gaps identified are communicated to the patient and/or the provider. After the visit, the patient can use a kiosk or a mobile device to check out, during which information on the gaps addressed during the visit are collected. The patient can also volunteer information regarding the gaps in care during check in or check out. When multiple parties such as specialists, laboratories, imaging, etc., are involved in providing care, our invention can orchestrate the coordination between multiple parties in providing care. Our invention provides automation to identify and address gaps in care for a roster of patients.

### BACKGROUND

Healthcare industry in the US is fragmented due to historical reasons and various factors, including specialization in sub-specialties. There are third party payers and prescription benefit management companies (PBMs), besides laboratories, rehabilitation centers, physical therapy centers, that play in the healthcare arena. Healthcare is delivered often in reactive mode. A patient visits a provider when he/she is sick. The provider examines the patient to arrive at specific diagnosis (there may be more than one) and performs one or more procedures to treat the health condition(s). But payers and other parties want to perform certain procedures proactively. For example, screening mammograms are recommended for women over 50 years of age. Some of these procedures are recommended for people with specific conditions or family history of diseases. In such cases, the patient may not be aware of the need to proactively approach a provider for care. Primary care providers manage a large roster of patients and they may not have the time or resources to proactively identify patients needing such care. This leads us to the problem of gaps in care. Gaps in care are exacerbated when multiple parties are involved in care delivery. In the mammogram example, a patient needs a referral to an imaging center that specializes in taking mammograms. The mammogram may need to be read by a certified radiologist. Addressing gaps in care often requires coordination between multiple parties, in addition to the patient and the provider, to provide care. Currently, some of the payers send a spread sheet periodically, listing gaps in care for each patient covered by the payer in the roster of the provider. The providers' staff is expected to manually go through the list, calling each patient in the list to work out the gaps in care. This is a tedious process that can benefit from automation.

In US patent application US 2009/0265189, Finn et al disclose a care coordination information system. The emphasis of their system is to provide a shared data store for coordinating care among multiple parties including providers, patients and case managers at payers. Their system enables coordination and prioritization of care in a large population. It does not tackle the gaps in care, which is a focus for our invention.

In US patent application 2011/0191115, Adnan A. Zalam discloses an integrated healthcare management system (ICMS). ICMS is programmed for the management of several diseases. Care coordinators can use ICMS to identify patients that need care and call them. They can facilitate setting up appointments with specialists and other providers based on need. Nurses and physician extenders can use ICMS to work with patients to ensure compliance with physician orders and to assist with appointments, transportation and delivery of medical services. The disclosure does not address gaps in care, which is a focus of our invention.

Our invention enables the provider to identify gaps in care and coordinate care for addressing such gaps with multiple parties. There can be several sources of information on gaps in care, including, but not limited to, the electronic health record, personal health record, payer's information systems, provider's information systems, pharmaceutical benefit management systems, laboratories, etc. Our invention gathers this information electronically where possible, to automate the compilation of gaps in care data for the patient roster of a provider. It also orchestrates the coordination of care between multiple parties to address the gaps identified.

### BRIEF DESCRIPTION OF THE DRAWINGS

FIG. 1 illustrates the preferred embodiment of our invention, where a network of backend information systems and kiosks work together to address gaps in care.

FIG. 2 illustrates by means of a process flow diagram the overall process for care coordination.

FIG. 3 illustrates by means of a flow chart the process for obtaining gaps in care addressed from claims data from a payer.

### DETAILED DESCRIPTION OF THE PREFERRED EMBODIMENTS

The present invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. The preferred embodiment of the invention will now be described with reference to the figures in which like numbers correspond to like references throughout.

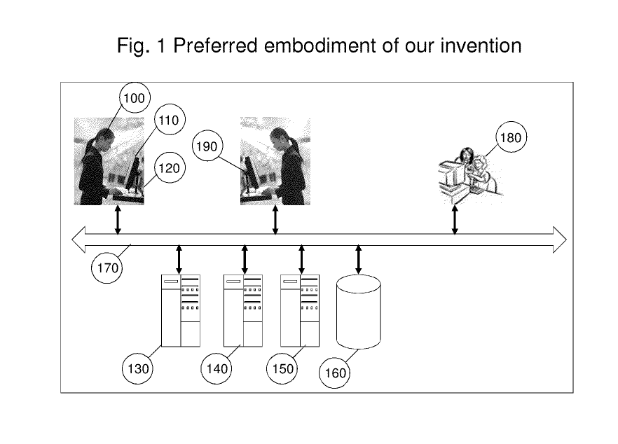

We illustrate the system of the preferred embodiment in FIG. 1. Patient 100 walks up to kiosk 110 in the physician office 120. The patient performs a check-in at kiosk 110. The kiosk looks up the patient and the patient's appointment if available in a back end practice management system/scheduling system 130. After positively identifying the patient, the patient's current medical record is retrieved from the practice management system 130, the prescription details and formularies are retrieved from the pharmacy benefit management system 140 and the claims and eligibility information is retrieved from payer information system 150. Information may be analyzed and the results may be cached in a local storage/data base management system (DBMS) 160. All of the above mentioned systems are connected by the network 170. Without loss of generality, one or more of the above mentioned systems may be non-local and may be accessed over a wide-area network (WAN) and/or the internet. The data and the guidelines concerning the gaps in care relevant to the patient 100 are retrieved and processed. The results are presented to the patient 100 and are printed in a care summary at the kiosk. The patient meets provider 180 and presents these documents to the provider to discuss the gaps in care and they take remedial action to address the gaps in care. The gaps addressable in this encounter may be addressed by the physician right away. The rest may be scheduled for a future visit or referred to other providers such as specialists, laboratories, imaging, etc. After completing the appointment, the patient checks out at kiosk 190. The patient updates information about the gaps covered and optionally feedback about the services provided during the encounter, at the checkout kiosk 190. (It may be noted that the check out kiosks and check in kiosks may be separate kiosks or the functions may be multiplexed on the same physical hard ware. There may be a plurality of kiosks employed for the check in function and for the checkout function, based on the size of the provider office 120.)

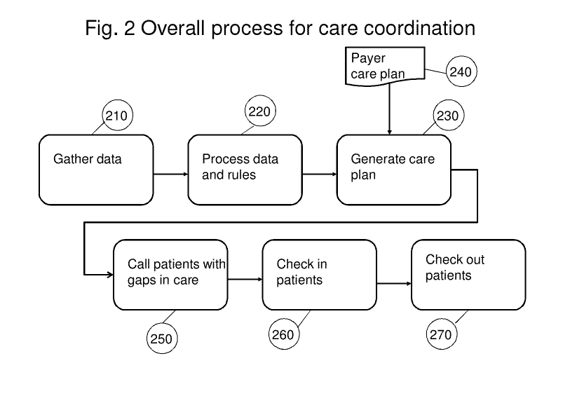

The overall process for care coordination is presented in FIG. 2. This may be implemented by means of a computer software program or a collection of computer software programs in the preferred embodiment. The process starts with gathering data from various sources in step 210. For example, data may be obtained from payers, providers, PBMs, laboratories, imaging, etc. The data gathered is analyzed and care guideline rules are run in step 220. Care plans are generated in step 230. If a payer provides a care plan with gaps in care to be addressed, this is fed via step 240. Patients on the roster who have one or more gaps in care are notified in step 250. When the patients arrive for an appointment, they are checked in step 260. Step 260 may include a review of systems and gaps in care, and the patient has the option to voluntarily disclose any gaps in care that may have already been addressed. At the end of the encounter, they are checked out in step 270. The gaps in care addressed during the encounter are obtained from the patient in step 270. Please note that this process flow diagram shows a chronological sequencing of steps performed for care coordination. There may be a plurality of patients found with gaps in care in step 230. Therefore steps 250, 260 and 270 are performed for each such patient found with gaps in care. For each such patient, they are performed in the chronological order. Between different patients found with gaps in care, there is no ordering implied on the steps to be performed. For example, it is not necessary to complete the check ins for all patients with gaps in care before executing the check out for any patient. It is not intended in the illustration.

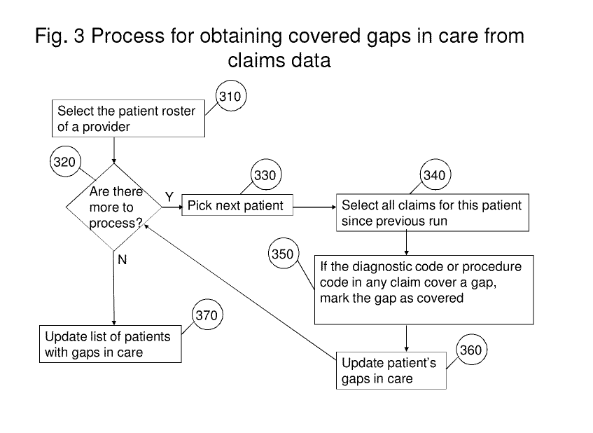

FIG. 3 presents a batch process by means of a flow diagram to identify the coverage of gaps in care by examining the claims received by payer(s). It starts with selecting the patient list (roster) of a provider in step 310. While there are more patients in the list in step 320, the next patient is picked in step 330. All the claims received for this patient since the previous run of the batch process are selected in step 340. If in any of these claims, a diagnostic code or a procedure code indicates that a gap in care for this patient is covered, then that specific gap in care is marked as covered in step 350. It is possible that more than one gap is marked as covered in this step. The gaps in care for the patient are updated in step 360 and the processing loops back to the next patient in the list in step 320. When all the patients in the roster are exhausted, the list of patients with gaps in care is updated in step 370, removing those patients whose gaps have been covered.

Practitioners of the art can realize that in a different embodiment, the gaps in care for a specific patient can be reviewed electronically by the provider on the display screen of a device instead of printing them on paper or in addition to printing them on paper, during an encounter. In yet another embodiment, the patient and the physician together review the gaps in care and chart out a plan of action together. Newer technologies such as large touch screen displays, multiple displays or Microsoft Surface Units can be used by the patient and provider to review these items together.

In a different embodiment, the system sets up an electronic visit or an e-visit for the patient to communicate with the provider. An e-care summary sheet generated for the e-visit lists the gaps in care identified, that can be discussed between the provider and the patient to arrive at a remedial action plan. The obvious benefit of the e-visit is that the patient does not need to physically visit the provider. The patient can connect and communicate with the provider from his/her mobile device or personal computer, using electronic methods for meeting on the internet. In a modification of this embodiment, the e-visit may be substituted by a phone call.

In a different embodiment, the notification to patients in step 250 of FIG. 2 can be accomplished by utilizing one or more alternate channels, including email, text messaging, physical mail, etc., in lieu of or in addition to the phone call utilized in the preferred embodiment. In a yet another embodiment, when a gap in care requires a third party service, such as a lab, imaging or a specialist referral, the system can generate such a referral to coordinate care delivery among multiple parties. In certain situations, a plurality of third parties may need to be coordinated for care delivery.

In a different embodiment, it is possible to implement the batch process of FIG. 3 as an incremental update via messaging. The payer publishes claims belonging to patients of a provider as they arrive on a channel to which the marking process of the provider listens to. When a claim received on the channel contains diagnostic code(s) and/or procedure code(s) that indicate that a gap in care is covered, that particular gap is marked as covered for the patient mentioned on the claim.

We described specific embodiments of the invention along with specific examples in the specific domain of healthcare. Practitioners of the art can derive several embodiments and domains of applicability of our invention.

The illustrations, and block diagrams of FIGS. 1, 2, and 3 illustrate the architecture, functionality, and operation of possible implementations of apparatus, systems, methods and computer program products according to various embodiments of the present invention. In this regard, each block in the flow charts or block diagrams may represent a module, electronic component, segment, or portion of code, which comprises one or more executable instructions for implementing the specified function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be understood that each block of the block diagrams and/or flowchart illustrations, and combinations of blocks in the block diagrams and/or flowchart illustrations, can be implemented by special purpose hardware-based systems which perform the specified functions or acts, or combinations of special purpose hardware and computer instructions.

In the drawings and specification, there have been disclosed typical illustrative embodiments of the invention and, although specific terms are employed, they are used in a generic and descriptive sense only and not for purposes of limitation, the scope of the invention being set forth in the following claims.

### Note Regarding Claims

In the discussions contained in this Patent Application we have included many major elements which obviously are bases for claims and included several claims for this invention. In addition, as is customary practice, we will request that the Patent Examiner point out any resulting claims we may have inadvertently missed, and that he/she point out any relevant changes that should be made to clarify the submitted claims, and that he/she point out any unintended duplication of claims should such inadvertently occur.

1. A system and method for care coordination in healthcare where the system consists of a network of kiosks and/or mobile devices and one or a plurality of backend information systems and the method consists of:
a. Identifying gaps in care for the patients at a provider
b. Notifying the patients to make appointment(s) to address the gaps in care
c. Checking in the patients at the provider office via a kiosk or a mobile device for an appointment
d. Identifying the addressed gaps in care by means of a check out kiosk or a mobile device and/or by monitoring claims submitted to the payer

2. The method of claim 1, where the gaps in care information and/or patient health records are obtained from other healthcare information systems via one or a plurality of electronic mechanisms, such as files, messages, remote calls, or other electronic formats.

3. The method of claim 1, where some of the gaps in care are identified by running rules against patient health data.

4. The method of claim 1, where the notification of patients is done by an automated means, including interactive voice response (IVR) via phone, by email, by text messaging, etc.

5. The method of claim 4, where the choice of the automated means is customizable by patient and is driven by the preference indicated by the patient.

6. The method of claim 1, where a check in of a patient at a provider office is automated via kiosk(s) and/or mobile device(s), where the patient goes through a review of systems to identify further gaps in care.

7. The method of claim 6, where the identified gaps in care are prioritized according to certain rules.

8. The method of claim 7, where the gaps in care are printed on a care summary sheet for the patient and/or the provider.

9. The method of claim 1, where a check out is performed at a kiosk and/or a mobile device, and where the patient can check off the gaps in care that have been addressed during the encounter.

10. The method of claim 1, where the check out is performed manually by a staff member assisting the patient and the gaps in care that have been addressed during the visit are noted and entered into the system by the staff member.

11. The method of claim 1, where the parties involved are informed about the gaps that have been addressed.

12. The method of claim 1, where a referral is sent to a third party, such as a lab, imaging or a specialist to address a gap in care.

13. The method of claim 12, where the system orchestrates the coordination of addressing a gap in care among a plurality of third party providers.

14. The method of claim 1, where the information on closure of a gap in care is obtained by electronic means, such a file, a message or a query.

15. The method of claim 1, where reports are generated on quality improvements from the gaps in care addressed.

16. The method of claim 1, where the physical encounter of the patient with the provider, to address one or more gaps in care, is replaced or augmented by an e-visit or a phone call.
